(19) United States
(12) Patent Application Publication
(10) Pub. No.: US 2025/0230685 A1
(43) Pub. Date: Jul. 17, 2025

(54) ASSEMBLY, SYSTEM, AND METHOD FOR OPERATIVELY ASSOCIATING A SMART LOCK TO A BARRIER

(71) Applicant: David Michael Skupien, Hawthorn Woods, IL (US)

(72) Inventor: David Michael Skupien, Hawthorn Woods, IL (US)

(21) Appl. No.: 19/018,298

(22) Filed: Jan. 13, 2025

Related U.S. Application Data
(60) Provisional application No. 63/619,951, filed on Jan. 11, 2024.

(51) Int. Cl. E05B 47/00; E05B 65/46

(52) U.S. Cl. CPC E05B 47/0001; E05B 65/46; E05B 2047/0091

(57) ABSTRACT

A lock assembly adapted to operatively associate a smart lock with any commercial or residential door, window, or barrier in a manner independent of the barrier frame or handle for the barrier. The lock assembly has a mounting flange that operatively associates a smart lock to any portion of the barrier frame, and moving receiver attached to the barrier itself, adjacent to the mounting flange.

### CROSS REFERENCE TO RELATED APPLICATION

This application claims the benefit of priority of U.S. provisional application No. 63/619,951, filed Jan. 11, 2024, the contents of which are herein incorporated by reference.

### BACKGROUND OF THE SUBJECT DISCLOSURE

The subject disclosure relates to locking systems and, more particularly, a lock mechanism adaptable with a smart lock for any commercial or residential door, window, cabinet, or other barrier, wherein the lock mechanism enables independence from the handle of the barrier.

A deadbolt, deadlock, spring bolt lock and other door locks are morticed into a periphery of the door to operatively associate with a bolt thrown into the door frame, using a key from either side or applying force directly to the deadbolt, to secure the door. The mortise is a pocket, recess, or hole cut through the door to make space the locking mechanism.

A “smart lock” is an electromechanical lock that is designed to perform locking and unlocking operations on a door when it receives a prompt via an electronic keypad, biometric sensor, access card, Bluetooth, Wi-Fi, or equivalent electromagnetic signal from a registered mobile device. Smart locks configured to be universal and adapted to almost any door or window do not exist. Also, most smart locks rely on batteries that need replacement.

Furthermore, current smart lock devices for doors and windows require removal of existing locks and utilization of the mortice and sometimes its reconfiguration as well as the door/window to match the smart lock. This can be a long and difficult task. As a result, many commercial doors and windows do not “adapt” to smart locks.

In short, existing smart locks for commercial doors, non-standard doors, and most windows are not universal and require extensive modifications that require the elimination of the existing locking mechanism.

Put another way, smart locks and universal mechanisms to easily adapt to almost any door or window do not exist. Also, most smart locks rely on batteries that need replacement. Most off-the-shelf smart locks require an exterior key and special cutouts, mortices, or modified mortices, which are not desirable, practical, optimal, or even possible for most commercial doors, residential sliding doors, overhead doors, windows, or drawers (i.e. portals). Often a smart lock upgrade is desired when a lock or handle breaks, keys get lost, or security upgrade is needed, but traditional locksmith solutions are prohibitively expensive.

As can be seen, there is a need for a universal smart lock mechanism adaptable with a standard smart lock for any commercial door, residential door, window, or other barrier, wherein the smart lock mechanism is barrier independent, so that the smart lock mechanism does not need to use the door mortice or be located anywhere near the barrier handle.

### SUMMARY OF THE SUBJECT DISCLOSURE

The subject disclosure is easily installed, can use almost any existing smart lock, and can leave the existing locking mechanism in place since the smart locking mechanism can be fixed along any portion of the periphery of the barrier it locks.

The locking mechanism embodied in the subject disclosure enables smart lock installation to almost any door or window, regardless of the existing lock. The inventive device also allows for AC power option or integration of a DC power supply without the need for moving wires or cables, thereby eliminating the need for batteries when adding a smart lock.

As a result, the subject disclosure allows many existing smart locks to be easily used on almost any commercial door, residential door, or window. The AC power supply option contemplated by the subject disclosure eliminates the need for batteries while allowing for robust cable and wiring.

The subject disclosure allows for quick and easy off-the-shelf smart lock installation to most any portal barriers. If desired, a keyed deadbolt cylinder is an option for use with this invention. If desired, this mechanism allows for easy integration of a DC power supply to eliminate batteries. Often a smart lock upgrade is desired when a lock or handle breaks, keys get lost, or security upgrade is needed; thus, the subject disclosure is a quick and easy way to avoid costly traditional locksmith solutions.

In sum, the subject disclosure offers a universal adapter kit to allow any smart lock to be installed on almost any door, window, or other barrier in need of locking.

In other words, the subject disclosure provides a universal deadbolt latch bracket assembly for smart lock adaptation and mechanisms to easily adapt a standard smart lock to almost any commercial or residential door, window or barrier, wherein the intrinsic mechanisms of the smart lock assembly allow for independence of the locking mechanism relative to the barrier, barrier frame, and its handle mechanisms.

In one aspect of the subject disclosure, a locking assembly for enabling a smart locking engagement between a barrier and an associated barrier frame at any point along the barrier frame, the locking assembly provides a moving receiver configured to attached to said barrier at an attachment point; and a barrier interface configured to attach to the barrier frame to removably retain a smart lock that operatively associates with a lock mechanism moveable between the barrier interface and the moving receiver forming a locked engagement.

In another aspect of the subject disclosure, the locking assembly further provides one or more of the following: wherein the barrier interface is a mounting plate, wherein the attachment point is at least one foot from a handle of the barrier, wherein the barrier is a commercial door, wherein the barrier is a window, or wherein the barrier is a drawer.

In yet another aspect of the subject disclosure, a method of locating a locking mechanism for a barrier away from a handle of the barrier, the method including the following: attaching a barrier interface of the lock assembly of claim 1 to a barrier frame of the barrier at an attachment point at least one foot away from the handle of the barrier; attaching the moving receiver to the barrier adjacent to the barrier interface; and moving a lock mechanism of the lock assembly of claim 1 to the locked engagement; and removably attaching a smart lock to the barrier interface so that the locked engagement is formed via activation of the smart lock by a registered smart device.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure, shown in a used condition along a window frame.

FIG. 2 is a perspective view of an exemplary embodiment of the subject disclosure, shown in a used condition without a smart lock.

FIG. 3 is a perspective view of an exemplary embodiment of the subject disclosure, shown in a used condition with the smart lock 35 operatively associated with a barrier interface, mounting bracket, or stationary sender 24.

FIG. 4 is a perspective view of an exemplary embodiment of the barrier interface, mounting bracket, or stationary sender 24 and the lock mechanism 22 of the subject disclosure.

FIG. 5 is an exploded perspective view of an exemplary embodiment of the barrier interface 24 and the lock mechanism 22 of the subject disclosure.

FIG. 6 is a perspective view of an exemplary embodiment of a ADA pull chain adapter 60 having a pulley element 62 to enable operative associations with the ADA pull chain 40 of the subject disclosure.

FIG. 7 is a perspective view of an exemplary embodiment of a smart lock mounting adapter 70 of the subject disclosure.

FIG. 8 is a perspective view of an exemplary embodiment of a disposable Installation alignment fixture 80 of the subject disclosure.

FIG. 9 is a perspective view of an exemplary embodiment of the mounting bracket 24 of the subject disclosure.

FIG. 10 is a perspective view of an exemplary embodiment of a lock component 90 of the subject disclosure.

FIG. 11 is a perspective view of an exemplary embodiment of the subject disclosure, shown in a used condition in a drawer environment.

FIG. 12 is a perspective view of an exemplary embodiment of the subject disclosure, shown in a used condition along a door frame, thereby enabling an ADA pull chain.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the subject disclosure provides a lock assembly adapted to operatively associate a smart lock with any commercial or residential door, window, or barrier in a manner independent of the frame or handle for the barrier.

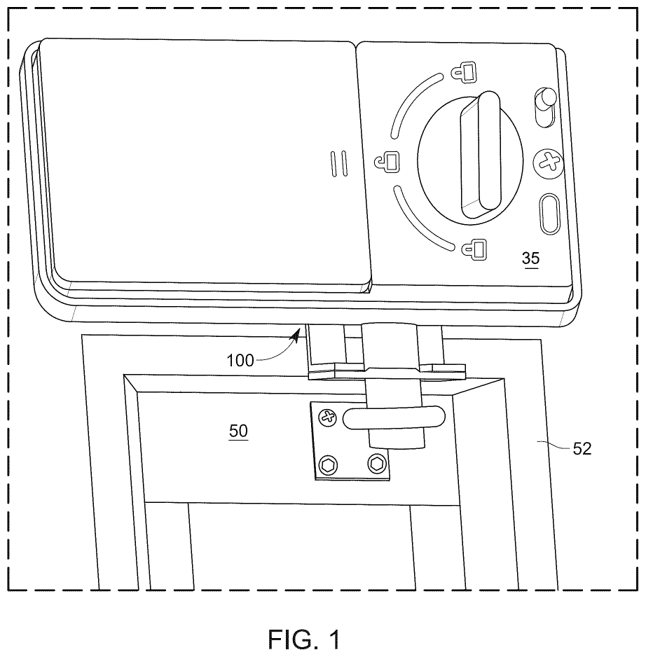

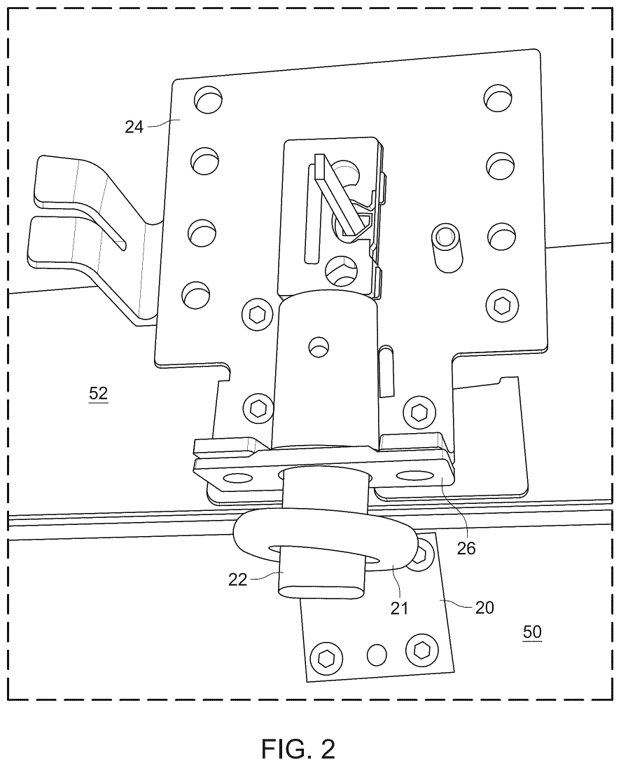

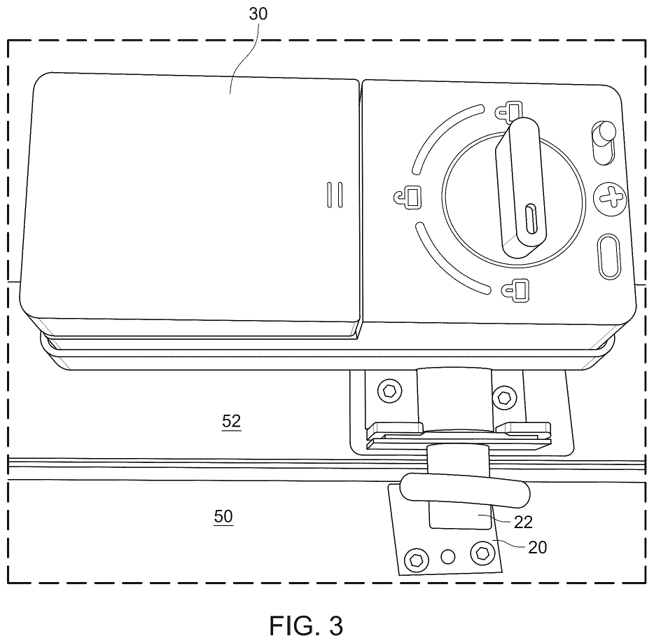

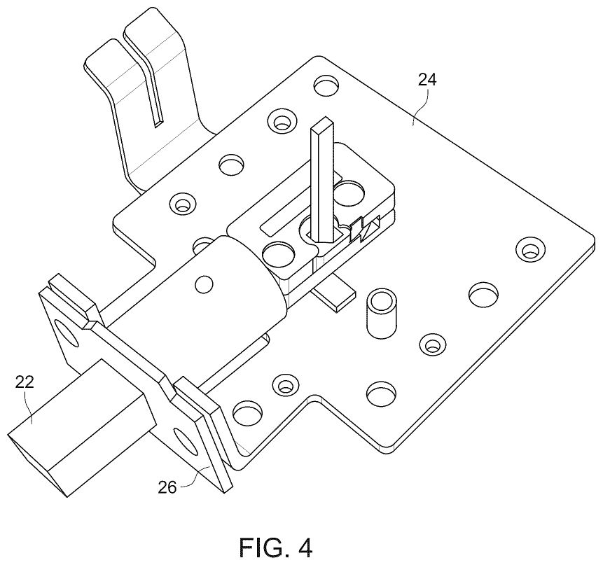

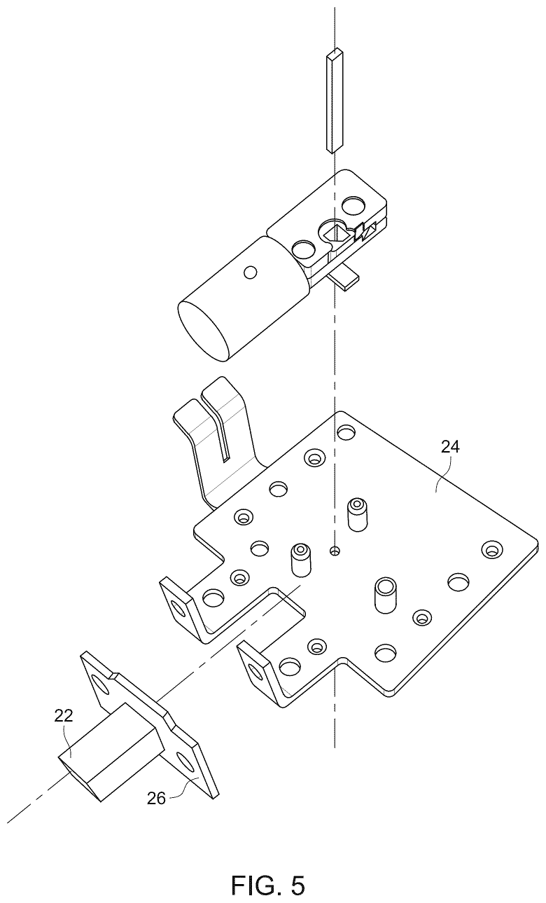

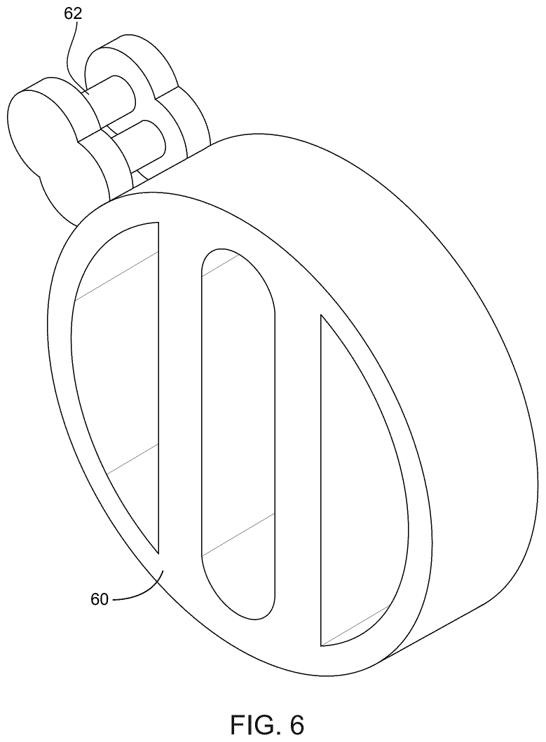

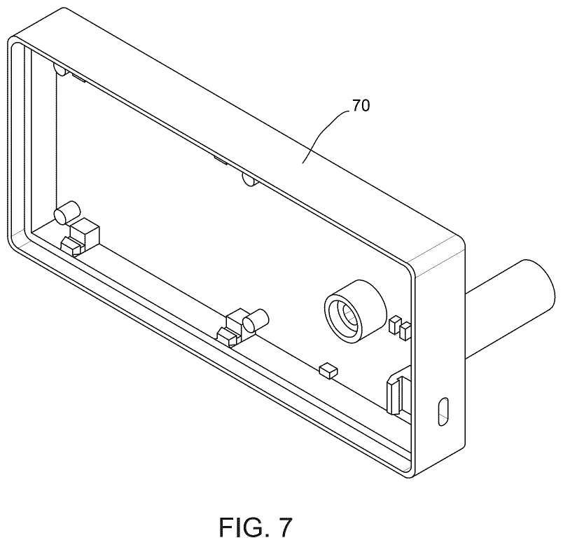

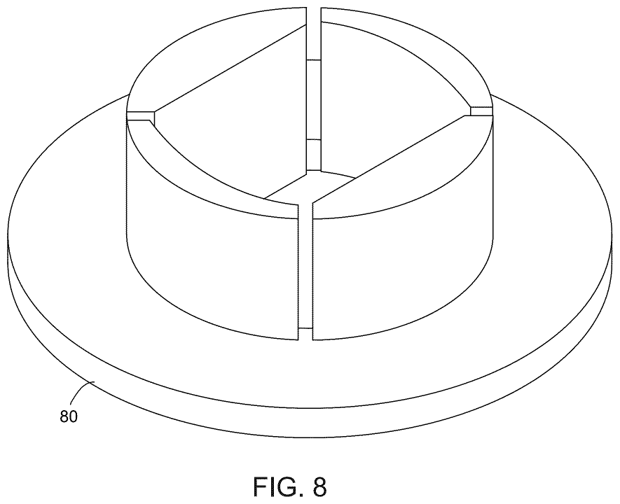

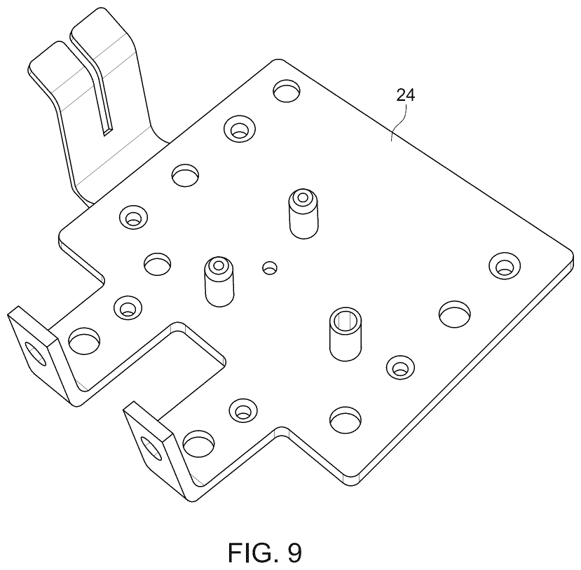

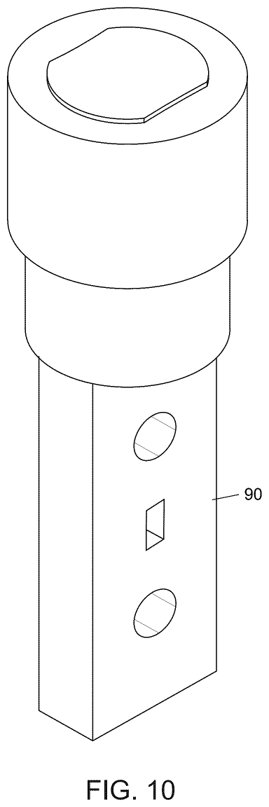

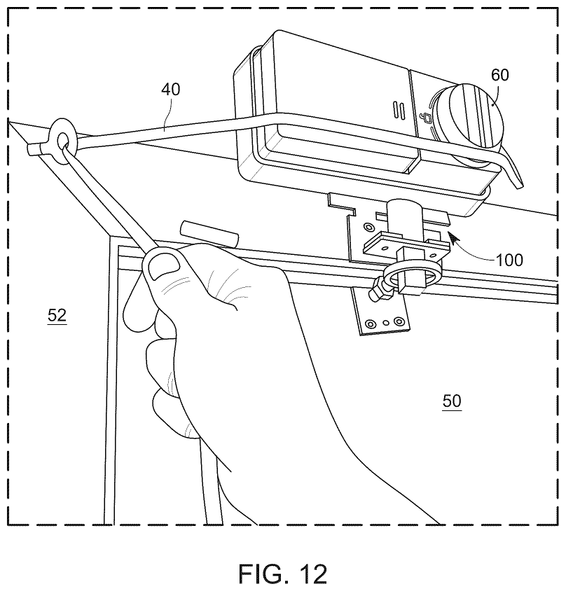

Referring to FIGS. 1 through 12, the subject disclosure offers a universal lock assembly 100 to allow any smart lock to operatively associated with any barrier. The universal lock assembly 100 is adapted to locate the smart lock along any portion of the fixed portion or frame of a portal or barrier. As a result of this “frame-independence” or “barrier-neutral” functionality the universal lock assembly 100 enables, for instance, robust cable and wiring options because the universal lock assembly 100 can be selectively placed anywhere along the barrier frame. Accordingly, a DC-power supply option that eliminates the need for batteries is possible where in prior art solutions may frustrate such an option since the prior art requires extensive modifications or is limited to the pre-existing mortice-area to accept a standard smart lock.

The smart lock assembly 100 may include the following systemic components: a lock plate 20, a lock mechanism 22, mounting bracket 24, a smart lock 35; one or more electrical connections 32, an optional tamper proof secondary lock; and, also optionally, an Americans with Disabilities Act (ADA) pull chain 40. The mounting bracket (or barrier interface) 24 is referred to a ‘stationary sender’ because it stays fixed to a frame 52 of the barrier 50 to be locked. The lock plate 20 is sometimes referred to as the ‘moving receiver’ as it move with the barrier 50.

Smart lock assembly 100 is operatively associated with installed onto barrier 50 (e.g., commercial door, window or the like) by way of the frame 52 of said barrier 50, then the smart lock 35 may be installed to said frame 52, by way of the mounting bracket 24, along any portion thereof. The selectivity of the mounting along frame 52 allows for electrical connections 32 to power the smart lock 35. In some embodiments, the tamper proof secondary lock 34 prevents unauthorized entry if the mechanism is tampered with. In some embodiments, the ADA pull chain 40 allows for ADA compatibility. The smart lock 35 may provide a battery component 30.

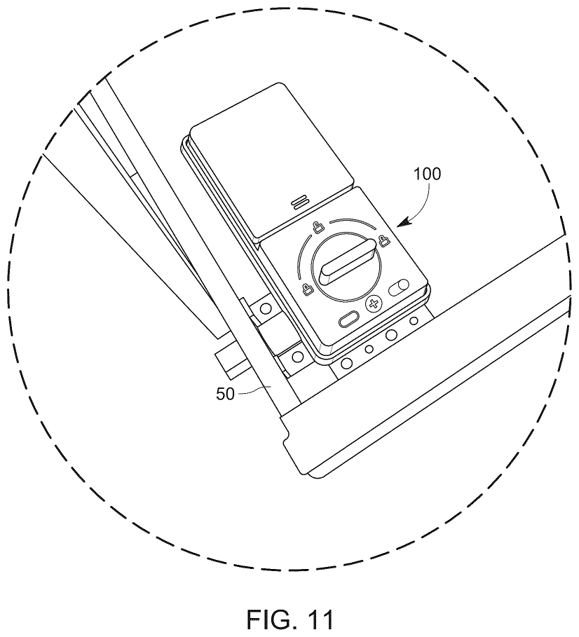

In other words, the subject disclosure enables a user to reposition a smart lock-enabled lock mechanism 22 (in some instances a deadbolt) anywhere along any barrier 50 (even a desk drawer, or the like, see FIG. 11). The lock plate or moving receiver 20 typically connects to the barrier 50. The moving receiver 20 may provide a strike plate 21 through which the lock mechanism 22 slides to form the locked engagement. The mounting bracket 24 mounts to the frame 52 of the barrier 50. The lock mechanism 22 and/or mounting bracket 24 may provide a deadbolt mounting flange 26. The mounting bracket/stationary sendr 24 provides components so that the smart lock 35 may be removably detached thereto. Accordingly, an embodiment of the subject disclosure contemplates the lock assembly 100 without the smart lock 35 that affords all the advantages disclosed herein, though in a manually operating locking device (sans the smart lock 35).

The elements of the subject disclosure allow for easy installation and integration of an off-the-shelf smart lock 35 to be integrated into almost any commercial or residential door, window or other barrier 50. Integrating the smart lock 35 on the fixed door frame side allows for power cords and cables to be integrated without the need for problematic moving power wires and cables which also eliminates the need for batteries.

To make this subject disclosure one needs to create a proper interface between the barrier 50, barrier frame 52, lock mechanism 22 and smart lock 35. The interface (mounting bracket 24) that can be attached along any place that it fits along the frame 52 and barrier 50 between the door and door frame, lock mechanism and smart lock. Optional elements include the DC power supply to eliminate batteries, the AC power supply (electrical connection), a tamperproof secondary lock, and an ADA pull chain 40.

A method of using the subject disclosure involves a person in need of solving the following problems: where a smart lock might not fit the door and/or frame; where an existing lock might be broken and therefore standard smart lock installation is prevented; and installation of a smart lock on a barrier without a lock.

As used in this application, the term “about” or “approximately” refers to a range of values within plus or minus 10% of the specified number. And the term “substantially” refers to up to 80% or more of an entirety. Recitation of ranges of values herein is not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A lock assembly for enabling a smart locking engagement between a barrier and an associated barrier frame at any point along the barrier frame, the locking assembly comprising:
a moving receiver configured to attached to said barrier at an attachment point; and
a barrier interface configured to attach to the barrier frame to removably retain a smart lock that operatively associates with a lock mechanism moveable between the barrier interface and the moving receiver forming a locked engagement.

2. The lock assembly of claim 1, further comprising wherein the barrier interface is a mounting plate.

3. The lock assembly of claim 1, wherein the attachment point is at least one foot from a handle of the barrier.

4. The lock assembly of claim 3, wherein the barrier is a commercial door.

5. The lock assembly of claim 3, wherein the barrier is a window.

6. The lock assembly of claim 3, wherein the barrier is a drawer.

7. A method of locating a locking mechanism from a barrier away from a handle of the barrier, the method comprising:
attaching a barrier interface of the lock assembly of claim 1 to a barrier frame of the barrier at an attachment point at least one foot away from the handle of the barrier;
attaching the lock moving receiver to the barrier adjacent to the barrier interface; and
moving a lock mechanism of the lock assembly of claim 1 to the locked engagement.

8. The method of claim 7, further comprising removably attaching a smart lock to the barrier interface so that the locked engagement is formed via activation of the smart lock by a registered smart device.
